(19) United States
(12) Patent Application Publication
(10) Pub. No.: US 2004/0009061 A1
(43) Pub. Date: Jan. 15, 2004

(54) Compressors

(75) Inventor: Gary McDonald, East Sussex (GB)

Correspondence Address: BURNS, DOANE, SWECKER & MATHIS, L.L.P., P.O. Box 1404, Alexandria, VA, 22313-1404, US

(73) Assignee: IMRA EUROPE S.A. UK RESEARCH CENTRE.

(21) Appl. No.: 10/614,788

(22) Filed: Jul. 9, 2003

(30) Foreign Application Priority Data
Jul. 13, 2002 (GB) 0216346.7

(51) Int. Cl. F03B 1/04

(52) U.S. Cl. 415/151

(57) ABSTRACT

The present invention provides a compressor comprising a housing 1 defining an air inlet passage 2 and a volute duct. A rotary impeller 6 is located within the housing 1 between the inlet passage 2 and the volute duct. A sleeve 3 is mounted axially in the inlet passage 2 and divides the inlet passage into a radially outer portion 4 and a radially inner portion 5. A plurality of inlet guide vanes 8 are positioned in the radially outer portion 4 and impart a rotary component of movement pre-swirl) to air passing through the inlet passage 2. A fluid cut-off valve 9 is positioned in the radially inner portion 5 and for selectively preventing fluid flow therethrough and diverting all of the air through the radially outer portion 4 of the inlet passage 2 at low mass flow rates.

### DESCRIPTION

### TECHNICAL FIELD

The present invention relates to compressors, and in particular to centrifugal compressors for supercharged engines.

### BACKGROUND ART

Centrifugal compressors can be used to supply air to a turbocharger unit for supercharging an engine. A conventional centrifugal compressor includes a housing defining a generally cylindrical inlet passage and a volute duct that serves as an outlet passage. The volute duct has a progressively varying sectional area.

An impeller is positioned between the inlet passage and the volute duct and includes a number of curved blades capable of imparting kinetic energy to the air when the impeller is rotated. Air is drawn through the inlet passage by the impeller and then supplied to the volute duct. The kinetic energy stored within the air is converted into static pressure as it expands under controlled conditions within the volute duct. The impeller can also be surrounded by a diffuser section which helps to direct the air leaving the impeller into the duct.

Conventional centrifugal compressors have a high efficiency area of operation but are less efficient at low mass flow rates. It is well known that the efficiency of conventional centrifugal compressors can be increased for low mass flow rates if the flow angle of the air is altered before it reaches the impeller. More particularly, the efficiency can be increased if the air is given a rotary component of movement in the same direction as the rotation direction of the impeller.

U.S. Pat. No. 6,039,534 describes one way of altering the flow angle of the inlet air by placing a plurality of inlet guide vanes in the inlet passage upstream of the impeller. The inlet guide vanes are pivotally mounted within a guide vane housing and can be selectively pivoted in unison to alter the flow angle of the air in response to different mass flow rates. This enables the centrifugal compressor to be operated at high efficiency over a wide range of mass flow rates.

There are two main problems with pivotally mounted inlet guide vanes. The first is the complex structure needed to mount the inlet guide vanes and control the pivoting movement of all the guide vanes in synchronisation. The second is the reduction in the sectional area of the inlet passage. The inlet guide vanes are closely spaced and therefore reduce the amount of air that can be drawn through the inlet passage by the impeller.

The present invention seeks to address these problems by providing a centrifugal compressor which has a simple structure with minimal reduction in the sectional area of the inlet passage.

Although the present invention has been described with reference to centrifugal compressors, the same principle can be applied to axial flow compressors as used in industrial gas turbine engines and jet engines.

### SUMMARY OF THE INVENTION

The present invention provides a compressor comprising a housing defining a fluid inlet passage and a fluid outlet passage, a rotary impeller located within the housing between the fluid inlet passage and the fluid outlet passage, and a plurality of inlet guide vanes in the inlet passage for imparting a rotary component of movement to fluid passing through the fluid inlet passage for increasing efficiency at low mass flow rates, characterised in that a sleeve is mounted axially in the fluid inlet passage and divides the fluid inlet passage into a radially outer portion and a radially inner portion, the inlet guide vanes are located in the radially outer portion of the fluid inlet passage, and a fluid flow cut-off valve is provided in the radially inner portion of the fluid inlet passage for selectively preventing fluid flow therethrough and diverting all of the fluid through the radially outer portion of the fluid inlet passage at low mass flow rates. The fluid flow cut-off valve is movable between a closed position where fluid can only flow through the radially outer portion of the fluid inlet passage and an open position where fluid can flow through the radially inner and outer portions of the fluid inlet passage. Because the inlet guide vanes are located in the radially outer portion of the fluid inlet passage it means that the radially inner portion of the fluid inlet passage has the least resistance to fluid flow. It will therefore be readily appreciated that when the fluid flow cut-off valve is open the majority of the fluid will pass through the radially inner portion of the fluid inlet passage.

At low mass flow rates the fluid flow cut-off valve is moved to the closed position such that the fluid is made to flow through the radially outer portion of the fluid inlet passage. The inlet guide vanes impart a rotary component of movement to the fluid in the same direction as the rotation direction of the impeller. This increases the efficiency of the compressor at low mass flow rates. At high mass flow rate, the compressor operates more efficiently if the fluid has no rotary component of movement. The fluid flow cut-off valve is therefore moved to the open position such that most of the fluid is made to flow straight through the radially inner portion of the fluid inlet passage.

The centrifugal compressor according to the present invention can therefore be operated at high efficiently over a wide range of mass flow rates.

The inlet guide vanes preferably have a fixed vane angle so that the compressor has a simple construction. However, it will be readily appreciated that the inlet guide vanes can be pivotally mounted such that they have a variable vane angle. The inlet guide vanes preferably have a vane angle of up to 70°.

The fluid flow cut-off valve is preferably located at an upstream portion of the sleeve but it can be mounted at either end of the sleeve or at any intermediate position. The fluid flow cut-off valve is preferably mounted by means of a pivotal mounting such as a rod that extends across the housing.

The inlet guide vanes are preferably fixed to the outer surface of the sleeve and preferably take the form of curved blades. The inlet guide vanes and the sleeve can be integrally formed or the inlet guide vanes can be welded or bonded to the sleeve.

The sleeve and the inlet guide vanes are preferably maintained in position by frictional contact with the housing as well as by the pivotal mounting for the fluid flow cut-off valve.

The sleeve preferably has a greater axial length than the inlet guide vanes but it can have the same axial length. The inlet guide vanes are preferably located at a downstream portion of the sleeve but they can be mounted at either end of the sleeve or at any intermediate position. The fluid flow cut off valve is preferably located upstream from the inlet guide vanes.

The sleeve preferably has an aerodynamic profile in the axial direction. This helps to ensure that the fluid flow past the sleeve is turbulence free.

The sleeve is preferably axially mounted such that the sectional area of the radially outer portion of the fluid inlet passage is the same as the sectional area of the radially inner portion of the fluid inlet passage. The sectional area occupied by the inlet guide vanes can be taken into consideration when calculating the distance between the outer surface of the sleeve and the housing.

The sleeve and the part of the housing that surrounds the sleeve are preferably substantially cylindrical. The housing also preferably tapers from the substantially cylindrical part towards the impeller such that the diameter of the fluid inlet passage adjacent the impeller is the same as that of the sleeve. The axial distance from the sleeve to the impeller is selected for optimum efficiency.

The compressor may also include a diffuser surrounding the impeller.

### DRAWINGS

FIG. 1 is a sectional view of a centrifugal compressor according to the present invention;

FIG. 2 is a cross-sectional view taken along line A-A of FIG. 1;

FIG. 3 is a perspective view showing the sleeve and inlet guide vanes of FIG. 1;

FIG. 4 is a graph showing the efficiency of the centrifugal compressor of FIG. 1 for different flow angles at the same operating speed; and

FIG. 5 is a graph showing the pressure ration of the centrifugal compressor of FIG. 1 for different flow angles at the same operating speed.

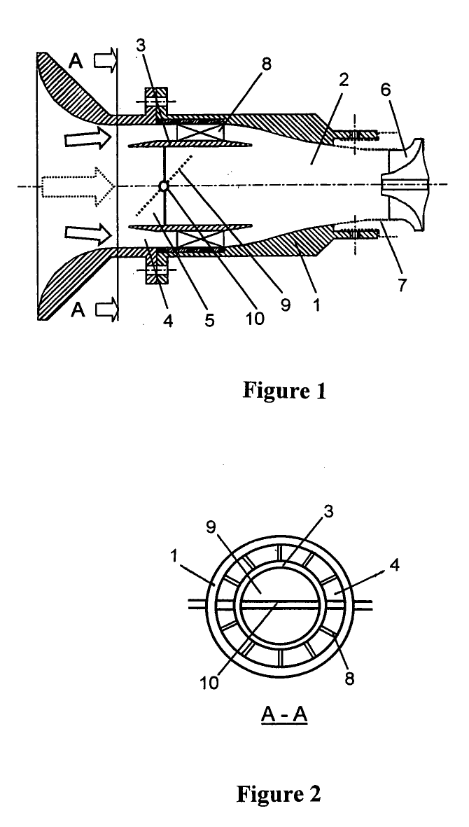

FIG. 1 shows a centrifugal compressor. The compressor has a housing 1 which defines an inlet passage 2 and a volute duct (not shown). A cylindrical sleeve 3 is mounted axially within the inlet passage 2 and divides the inlet passage into a radially outer portion 4 and a radially inner portion 5.

The housing 1 has a substantially cylindrical portion that surrounds the sleeve 2. The inner diameter of the cylindrical portion of the housing is approximately √2 times the inner diameter of the sleeve 3 such that the sectional flow area through the radially outer portion 4 is the same as that through the radially inner portion 5.

A rotary impeller 6 is located within the housing 1 between the inlet passage 2 and the volute duct (not shown). As the impeller 6 rotates, air is drawn through the inlet passage 2 and supplied to the volute duct (not shown).

The housing 1 also has a tapered portion extending from the cylindrical portion towards the impeller 6 and ending in a substantially cylindrical collar 7. The inner diameter of the collar 7 is the same as the inner diameter of the sleeve 3, so that at maximum mass flow rates the intake air can pass through the radially inner portion 5 and through the cylindrical collar 7 without compression.

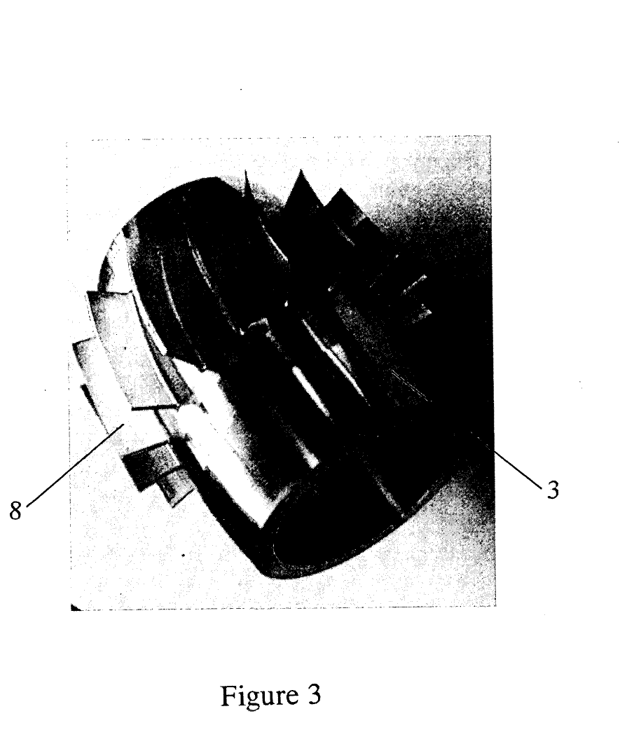

With reference to FIG. 3, a number of curved blades 8 are integrally formed on the outer surface of the sleeve 3. The blades 8 are located in the radially outer portion 4 of the inlet passage 2 and impart a rotary component of movement in the same direction as the rotation direction of the impeller 6 to any air passing through the radially outer portion 4 (represented by the solid block arrows in FIG. 1). The step of imparting a rotary component of movement to the air passing through the inlet passage 2 is commonly known as “pre-swirl”.

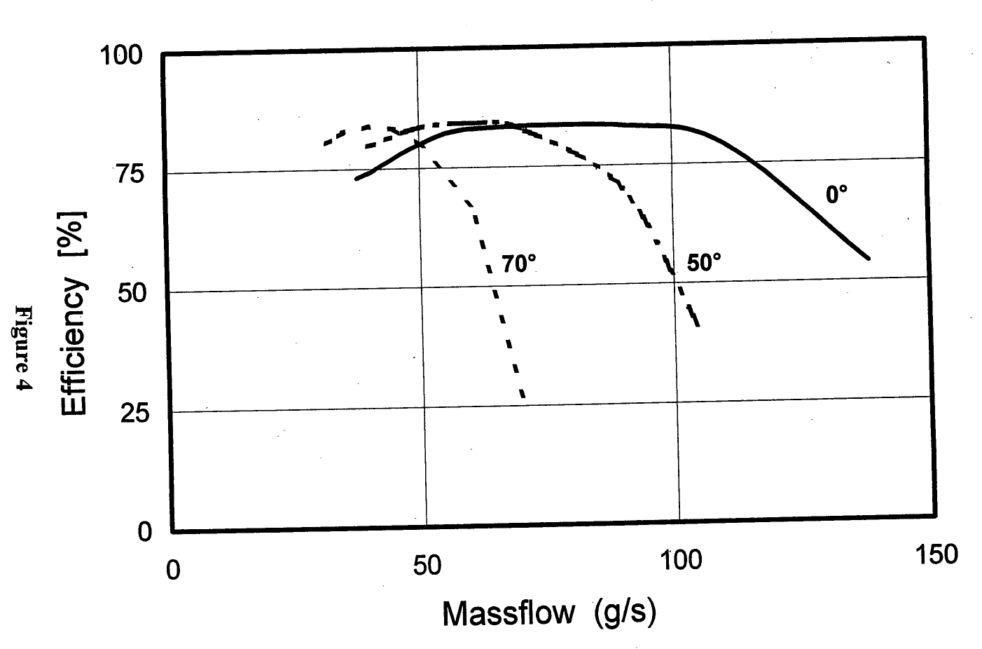

The curvature of the blades 8 is selected to impart a particular swirl angle to the air flowing though the radially outer portion 4. FIG. 4 shows how the efficiency of the compressor varies with the mass flow of air passing through the inlet passage 2 and the swirl angle. It is clear from FIG. 4 that 0° (no swirl angle) is most efficient at high mass flow rates but is less efficient for mass flow rates below 60 g/s. For mass flow rates below this figure it is more efficient for the curved blades 8 to impart a swirl angle of 50° or 70° to the air. The operational speed of the impeller 6 is fixed.

A flap valve 9 is located in the radially inner portion 5 of the inlet passage 2 as shown in FIGS. 1 and 2. The flap valve 9 is pivotally mounted on a shaft 10 and can be pivoted between a closed position (represented by the block line in FIG. 1) and an open position (represented by the dotted line in FIG. 1). The shaft 10 is positioned such that it does not interfere with the curved blades 8. Although both ends of the shaft 10 are shown to be inserted into the housing 1, it is possible that only one end is inserted into the housing so as to support the flap valve 9. When the compressor is operating at high mass flow rate, for example above 60 g/s, then the flap valve 9 is pivoted to the open position and the air is drawn through the radially inner portion 5 (as represented by the dotted arrow in FIG. 1) and the radially outer portion 4. It will be readily appreciated that only a small amount of air will be drawn through the radially outer portion 4 of the inlet passage 2 because of the increased resistance to air flow compared to the radially inner portion 5. This means that the majority of the air supplied to the impeller 6 at high mass flow rates will not be swirled.

When the compressor is operating as low mass flow rate, for example below 60 g/s, then the flap valve 9 is pivoted to the closed position and the air is drawn only through the radially outer portion 4 of the inlet passage 2 where the curved blades 8 impart a particular swirl angle in the rotation direction of the impeller 6.

In this way the compressor is able to maximise its efficiency for different mass flow rates.

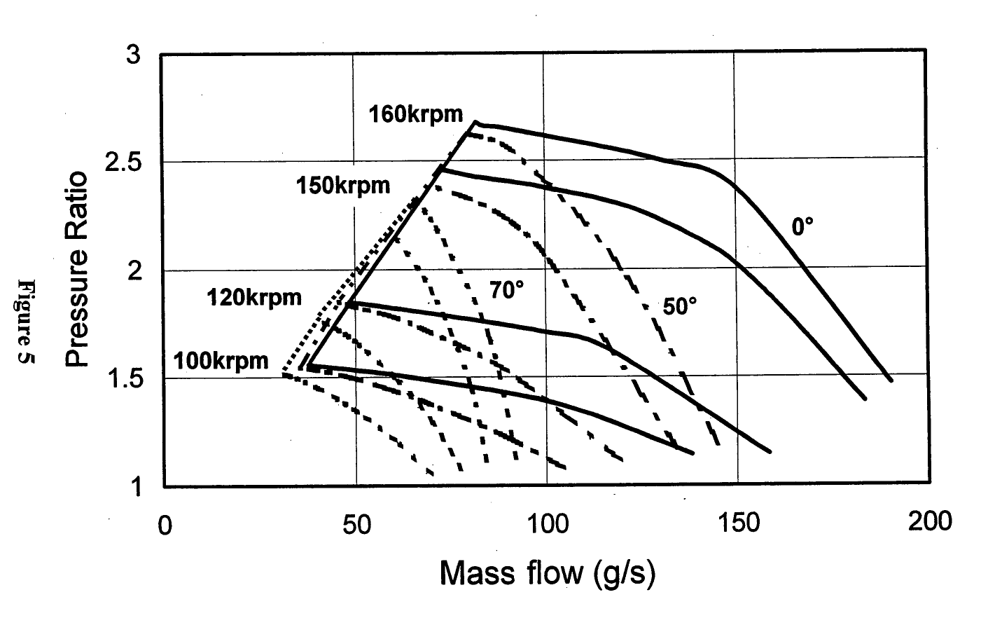

FIG. 5 shows how the pressure ratio of the compressor varies with the mass flow rate of air passing through the inlet passage 2 and the swirl angle. It is clear from FIG. 5 that a 70° swirl angle is most efficient at reducing the surge area.

1. A compressor comprising:
a housing defining a fluid inlet passage and a fluid outlet passage;
a rotary impeller located within the housing between the fluid inlet passage and the fluid outlet passage;
a plurality of inlet guide vanes in the inlet passage for imparting a rotary component of movement to fluid passing through the fluid inlet passage for increasing efficiency at low mass flow rates;
characterised in that:
a sleeve is mounted axially in the fluid inlet passage and divides the fluid inlet passage into a radially outer portion and a radially inner portion;
the inlet guide vanes are located in the radially outer portion of the fluid inlet passage; and
a fluid flow cut-off valve is provided in the radially inner portion of the fluid inlet passage for selectively preventing fluid flow therethrough and diverting all of the fluid through the radially outer portion of the fluid inlet passage at low mass flow rates.

2. A compressor according to claim 1, wherein the inlet guide vanes have a fixed vane angle.

3. A compressor according to claim 2, wherein the inlet guide vanes have a vane angle of up to 70°.

4. A compressor according to claim 2, wherein the fluid flow cut-off valve is located in the sleeve by means of a pivotal mounting.

5. A compressor according to claim 4, wherein the fluid flow cut-off valve is located at an upstream portion of the sleeve.

6. A compressor according to claim 2, wherein the inlet guide vanes are fixed to the outer surface of the sleeve.

7. A compressor according to claim 6, wherein the sleeve and the inlet guide vanes are maintained in position by frictional contact with the housing and the pivotal mounting for the fluid flow cut off valve.

8. A compressor according to claim 2, wherein the sleeve has a greater axial length that that of the inlet guide vanes.

9. A compressor according to claim 2, wherein the inlet guide vanes are located at a downstream portion of the sleeve.

10. A compressor according to claim 1, wherein the diameter of the fluid inlet passage adjacent the impeller is the same as the diameter of the sleeve.
